(19) United States
(12) Patent Application Publication
(10) Pub. No.: US 2013/0285975 A1
(43) Pub. Date: Oct. 31, 2013

(54) TOUCH SCREEN PANEL AND TOUCH SCREEN APPARATUS

(71) Applicants: Kyung Hee HONG, Suwon (KR); Hyun Suk LEE, Suwon (KR); Tah Joon PARK, Suwon (KR); Sang Ho LEE, Suwon (KR); Moon Suk JEONG, Suwon (KR); Yong Il KWON, Suwon (KR); Byeong Hak JO, Suwon (KR)

(72) Inventors: Kyung Hee HONG, Suwon (KR); Hyun Suk LEE, Suwon (KR); Tah Joon PARK, Suwon (KR); Sang Ho LEE, Suwon (KR); Moon Suk JEONG, Suwon (KR); Yong Il KWON, Suwon (KR); Byeong Hak JO, Suwon (KR)

(73) Assignee: SAMSUNG ELECTRO-MECHANICS CO., LTD., Suwon (KR)

(21) Appl. No.: 13/556,806

(22) Filed: Jul. 24, 2012

(30) Foreign Application Priority Data
Apr. 26, 2012 (KR) 10-2012-0043980

(51) Int. Cl. G06F 3/044; G06F 3/041

(52) U.S. Cl. 345/174; 345/173

(57) ABSTRACT

There are provided a touch screen panel and a touch screen apparatus. The touch screen panel includes a plurality of first electrodes formed on a substrate and extending in a first axis direction; and a plurality of second electrodes formed on the substrate and extending in a second axis direction perpendicular to the first axis direction, wherein a plurality of first slits are provided in a diagonal direction with respect to the first axis direction and the second axis direction between the plurality of first electrodes and the plurality of second electrodes, and at least one second slit is formed within each of the plurality of second electrodes.

### CROSS-REFERENCE TO RELATED APPLICATIONS

This application claims the priority of Korean Patent Application No. 10-2012-0043980 filed on Apr. 26, 2012, in the Korean Intellectual Property Office, the disclosure of which is incorporated herein by reference.

### BACKGROUND OF THE INVENTION

1. Field of the Invention

The present invention relates to a touch screen panel in which slits are formed between a plurality of electrodes and within a plurality of electrodes to improve linearity of a change in capacitance according to a touch, enhance a signal-to-noise ratio (SNR) of a signal generated according to a touch, and enhance accuracy of touch determination accordingly, and a touch screen apparatus.

2. Description of the Related Art

A touch sensing apparatus such as a touch screen, a touch pad, or the like, is an input device attached to a display device to provide an intuitive user data input method, which is commonly applied to various electronic devices such as mobile phones, personal digital assistants (PDAs), navigation devices, and the like. In particular, as demand for smart phones has increased, the adoption of touch screens as touch sensing apparatuses that support various input methods in a limited form factor has also increased.

A touch screen applied to a portable device may be classified as a resistive touch screen or as a capacitive touch screen, according to how a touch is sensed thereby. The application of capacitive touch screens, having advantages such as a relatively long lifespan and various input methods and gestures being easily implementable therein, is growing. In particular, in comparison to resistive touch screens, capacitive touch screens allow for a multi-touch interface to be easily implemented, such that they may be extensively applied to devices such as smart phones, and the like.

The capacitive touch screen includes a plurality of electrodes having a certain pattern, and here, electrodes should be formed on the majority of regions of the touch screen corresponding to an effective display area of a display device and the plurality of electrodes should have a certain pattern to sense a touch. When a touch is applied and a touched position is calculated, interpolation is performed on a unidimensional line in order to implement a low power touch screen panel (TSP) system supporting a fast response speed and having reliability, in many cases. Thus, a transition of capacitance values according to touched positions may be linear. If the transition of capacitance values according to touched positions is not linear, a touch error equivalent to a difference between an actually obtained capacitance value and an interpolation value at each position of a touch is added in the system. Thus, an electrode pattern may have a shape for improving linearity of capacitance values according to touched positions.

Patent Document 1 discloses a configuration including a plurality of openings formed in sensing electrodes of a touch screen, but is silent regarding an improvement of linearity in sensing a touch, or the like. Also, Patent Document 2 discloses forming openings at points at which a plurality of electrodes intersect, but this is aimed at enhancing a change in capacitance for determining a touch without clarifying content of an improvement of linearity, like Patent Document 1.

### RELATED ART DOCUMENT

(Patent Document 1) Korean Patent No. KR 10-1050464
(Patent Document 2) US Patent Application Publication No. US 2011/0156930

### SUMMARY OF THE INVENTION

An aspect of the present invention provides a capacitive touch screen apparatus or a touch screen panel in which a plurality of first slits are formed between a plurality of electrodes provided on a substrate such that they are perpendicular to a length direction of the respective electrodes, and at least one second slit is formed within at least some of the plurality of electrodes, in order to guarantee linearity over a change in capacitance according to a position at which a touch is applied and improve a signal-to-noise ratio (SNR) of a change in capacitance, thereby accurately sensing a touch without having to add an additional algorithm or a circuit configuration to a circuit unit for sensing a touch.

According to an aspect of the present invention, there is provided a touch screen panel including: a plurality of first electrodes formed on a substrate and extending in a first axis direction; and a plurality of second electrodes formed on the substrate and extending in a second axis direction perpendicular to the first axis direction, wherein a plurality of first slits are provided in a diagonal direction with respect to the first axis direction and the second axis direction between the plurality of first electrodes and the plurality of second electrodes, and at least one second slit is formed within each of the plurality of second electrodes.

The at least one second slit may be formed to intersect with the plurality of first slits within each of the plurality of second electrodes.

A portion of the at least one second slit may be formed to be parallel to at least one of the plurality of first slits within each of the plurality of second electrodes.

The at least one second slit may be formed to be parallel to any one of the first axis direction and the second axis direction within each of the plurality of second electrodes.

The at least one second slit may be formed to have one end in a length direction thereof connected to at least one of the plurality of first slits within each of the plurality of second electrodes.

The at least one second slit may be formed to be separated from the plurality of first slits within each of the plurality of second electrodes.

The at least one second slit may be formed to be symmetrical in at least one of the first axis direction and the second axis direction based on intersections between the plurality of first electrodes and the plurality of second electrodes within each of the plurality of second electrodes.

The touch screen panel may further include a circuit unit sequentially applying a predetermined driving signal to the plurality of first electrodes, and determining a touch by detecting a change in capacitance from the plurality of second electrodes intersecting the first electrodes to which the driving signal has been applied.

The touch screen panel may further include a dummy electrode formed within at least one of the plurality of first slits and the at least one second slit.

According to another aspect of the present invention, there is provided a touch screen apparatus including: a panel unit including two or more electrodes and having a plurality of unit sensing cells having a quadrangular shape; and a circuit unit electrically connected to the plurality of unit sensing cells to determine a touch, wherein each of the plurality of unit sensing cells includes a plurality of first slits extending in a diagonal direction and one or more second slits parallel to the plurality of first slits, the plurality of first slits are formed between the two or more electrodes, and the one or more second slits are formed within at least one of the two or more electrodes.

Each of the plurality of unit sensing cells having the quadrangular shape may include first and second electrodes intersecting at a center thereof.

The first and second electrodes included in each of the plurality of unit sensing cells may be connected to first and second electrodes included in an adjacent unit sensing cell.

The first electrode included in each of the plurality of unit sensing cells may be connected to the first electrode included in the adjacent unit sensing cell in a first axis direction, and the second electrode included in each of the plurality of unit sensing cells may be connected to the second electrode included in the adjacent unit sensing cell in a second axis direction.

The one or more second slits may be formed to be symmetrical in at least one of the first axis direction and the second axis direction based on the center of each of the plurality of unit sensing cells having the quadrangular shape.

The plurality of first slits may be formed between the two or more electrodes to be symmetrical in the first axis direction and the second axis direction based on a center of each of the plurality of unit sensing cells having the quadrangular shape.

The circuit unit may apply a predetermined driving signal to the first electrode and determine a touch by detecting a change in capacitance from the second electrode.

Each of the plurality of unit sensing cells may further include a dummy electrode provided within at least one of the plurality of first slits and the one or more second slits.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view showing an exterior of an electronic device having a touch screen apparatus according to an embodiment of the present invention;

FIGS. 2 and 3 are plan views showing a touch screen apparatus according to an embodiment of the present invention;

FIG. 4 is a view showing a touch screen apparatus according to an embodiment of the present invention;

FIGS. 5A, 5B, 6A and 6B are views explaining slits included in electrodes of a touch screen apparatus according to an embodiment of the present invention; and

FIGS. 7 and 8 are graphs explaining an operation of the touch screen apparatus according to an embodiment of the present invention.

### DETAILED DESCRIPTION OF THE PREFERRED EMBODIMENT

Embodiments of the present invention will be described in detail with reference to the accompanying drawings. These embodiments will be described in detail in order to allow those skilled in the art to practice the present invention. It should be appreciated that various embodiments of the present invention are different but are not necessarily exclusive. For example, specific shapes, configurations, and characteristics described in an embodiment of the present invention may be implemented in another embodiment without departing from the spirit and the scope of the present invention. In addition, it should be understood that the position and arrangement of individual components in each disclosed embodiment may be changed without departing from the spirit and the scope of the present invention. Therefore, a detailed description described below should not be construed as being restrictive. In addition, the scope of the present invention is defined only by the accompanying claims and their equivalents if appropriate. Similar reference numerals will be used to describe the same or similar functions throughout the accompanying drawing.

Hereinafter, embodiments of the present invention will be described in detail with reference to the accompanying drawings so that those skilled in the art may easily practice the present invention.

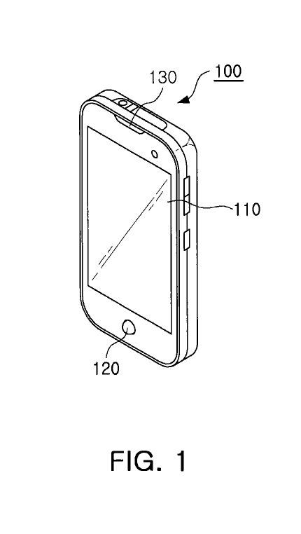

FIG. 1 is a view showing an electronic device to which a touch sensing apparatus is applicable according to an embodiment of the present invention. With reference to FIG. 1, an electronic device 100 according to the present embodiment includes a display device 110 for outputting an image, an input unit 120, an audio unit 130 for outputting voice audio, and the like, and may have a touch sensing apparatus integrated with the display device 110.

As illustrated in FIG. 1, in case of a mobile device, a touch sensing apparatus is generally integrated with a display device, and here, the touch sensing apparatus is required to have light transmittance sufficient to transmit through an image displayed on the display unit. Thus, the touch sensing apparatus may be implemented by forming a sensing electrode made of a material such as indium-tin-oxide (ITO), indium-zinc oxide (IZO), zinc oxide (ZnO), carbon nanotubes (CNT), a conductive polymer, or graphene which is transparent and has electric conductivity on a base substrate made of a transparent film material such as polyethylene terephthalate (PET), polycarbonate (PC), polyethersulfone (PES), polyimide (PI), or the like. Also, an embodiment of forming a sensing electrode to have a mesh structure in which metal strips having a very thin width are densely disposed may also be applicable. A wiring pattern connected to the sensing electrode made of a transparent conductive material is disposed in a bezel region of the display device, and here, the wiring pattern is visually shielded by the bezel region, so the wiring pattern may also be made of a metal such as silver (Ag), copper (Cu), or the like.

Obviously, in the case that the touch sensing apparatus is not required to be integrally provided with a display device such as a touch pad of a notebook computer, or the like, the touch sensing apparatus may be fabricated by simply patterning a sensing electrode with metal on a circuit board. However, for the sake of explanation, a touch sensing apparatus and a touch sensing method according to an embodiment of the present invention will be described based on a touch screen.

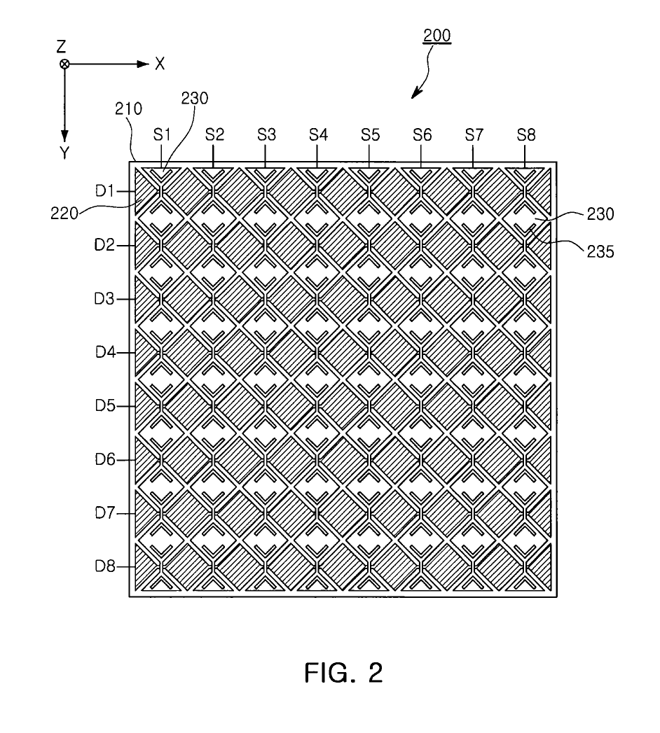

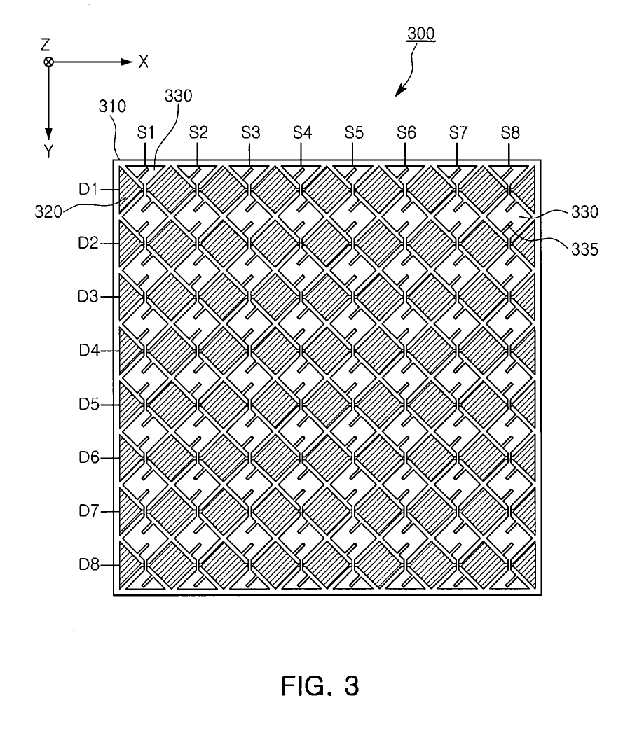

FIGS. 2 and 3 are plan views showing a touch screen panel according to an embodiment of the present invention.

With reference to FIG. 2, a touch screen panel 200 according to the present embodiment includes a substrate 210 and a plurality of unit electrodes 220 and 230 prepared on the substrate 210. Although not shown in FIG. 2, each of the plurality of unit electrodes 220 and 230 may be electrically connected to a wiring pattern of a circuit board attached to one end of the substrate 210 through a wire and a bonding pad. A controller integrated circuit (IC) may be mounted on the circuit board to detect a sense signal generated from the plurality of unit electrodes 220 and 230 and determine a touch based on the detected sense signal.

In the case of the touch screen, the substrate 210 may be a transparent substrate for forming the unit electrodes 220 and 230 and may be made of a plastic material such as polyimide (PI), polymethylmethacrylate (PMMA), polyethylene terephthalate (PET), polycarbonate (PC), or tempered glass.

Also, apart from the region in which the unit electrodes 220 and 230 are formed, a certain printed region for a wiring connected to the unit electrodes 220 and 230 may be formed on the substrate 210 in order to visually shield the wiring generally made of an opaque metal.

The plurality of unit electrodes 220 and 230 may be provided on one surface or both surfaces of the substrate 210, and in the case of the touch screen apparatus, the unit electrodes 220 and 230 may be made of indium-tin-oxide (ITO), indium-zinc oxide (IZO), zinc oxide (ZnO), carbon nanotubes (CNT), a graphene material, or the like. Although the unit electrodes 220 and 230 have a rhombus, or diamond-shaped, pattern are illustrated in FIG. 2, the unit electrodes 220 and 230 may have various polygonal patterns such as a rectangular pattern, a triangular pattern, or the like.

Some of the plurality of unit electrodes 220 and 230 may be connected to form first electrodes extending in an X-axis direction and second electrodes extending in a Y-axis direction. The first and second electrodes may be formed on both surfaces of the substrate 210 or on different substrates to intersect each other. When both the first and second electrodes are formed on one surface of the substrate 210, a certain insulating layer may be formed at the intersections between the first and second electrodes.

The controller IC electrically connected to the plurality of unit electrodes 220 and 230 to sense a touch detects a change in capacitance generated in the plurality of unit electrodes 220 and 230 and sense a touch based on the detected change in capacitance. The first electrodes may be connected to channels defined as D1 to D8 to receive a certain driving signal, and the second electrodes may be connected to channels defined as S1 to S8 and used to detect a sense signal by the touch sensing apparatus. Here, the controller IC may detect a change in mutual capacitance generated between the first and second electrodes as a sense signal and may operate such that it sequentially applies a driving signal to the respective first electrodes and simultaneously detects a change in capacitance from the second electrodes.

In the present embodiment, the plurality of unit electrodes 220 and 230 are connected in the X-axis direction or the Y-axis direction on a two-dimensional plane defined as an X-Y coordinate plane to constitute a plurality of first electrodes and a plurality of second electrodes. The plurality of first and second electrodes are formed to substantially entirely shield one surface of the substrate 210, and accordingly, a plurality of first slits 225 having a very narrow width are formed between the plurality of first and second electrodes. Also, one or more second slits 235 may be additionally formed within some of the unit electrodes 230 constituting the plurality of second electrodes. One or more second slits 235 may be symmetrical in shape over X axis or Y axis based on intersections between the plurality of first and second electrodes.

In a different point of view, a unit sensing cell 240 including at least one of the respective unit electrodes 220 and 230 may be defined. As shown in FIG. 2, the unit sensing cell 240 may have a quadrangular shape and includes one or more unit electrodes 220 and 230 therein. Also, one or more first electrodes extending in the X-axis direction and one or more second electrodes extending in the Y-axis direction may be included in a single unit sensing cell 240.

The plurality of first slits 225 may extend toward the vertex of the quadrangular shape along the X axis or the Y axis based on the point at which diagonal lines in the unit sensing cell 240 having a quadrangular shape intersect, based on the center of the unit sensing cell 240. Namely, the plurality of first slits 225 may be parallel to the diagonal lines in a single quadrangular unit sensing cell 240. In FIG. 2, it is illustrated that a portion of the second slit 235 and the first slit 225 are parallel to each other, but this is merely a preferred embodiment of the present invention and the present invention is not limited thereto.

Meanwhile, FIG. 2 illustrates that the second slits 235 are formed only in the unit electrodes 230 constituting the second electrodes, but this is based on the assumption that the second electrodes are electrodes for detecting a sense signal corresponding to a change in capacitance. As described above, the controller IC sequentially applies a driving signal to the individual first electrodes connected to the channels D1 to D8 and determines a touch by detecting a change in capacitance from the second electrodes connected to the channels S1 to S8. Namely, since the second electrodes are electrodes for detecting a change in capacitance, although the second slits 235 are formed only in the second electrodes, the object and effect of the present invention can be achieved. By forming the second slits 236 in the second electrodes that detect a change in capacitance, linearity according to a movement of a touch can be improved and the strength of a sense signal according to the touch can be enhanced. This will be described later.

Also, in the present embodiment, one or more dummy electrodes may be provided in at least any one of the plurality of first and second slits 225 and 235. The dummy electrodes are electrically separated from all of the unit electrodes 230 constituting the first and second electrodes and may be made of the same material as that of the unit electrodes 230, namely, a transparent conductive material such as ITO, ZnO, IZO, CNT, CP, or the like, or a metal mesh. By forming the one or more dummy electrodes within the plurality of first and second slits 225 and 235, a pattern-visible phenomenon of the first and second electrodes can be prevented and even visibility can be implemented.

FIG. 3 is a plan view of a touch screen apparatus according to an embodiment of the present invention.

With reference to FIG. 3, a touch screen panel 300 according to the present embodiment includes a substrate 310 and a plurality of unit electrodes 320 and 330. As in FIG. 2, some 320 of the plurality of unit electrodes 320 and 330 are connected to each other in the X-axis direction to form a plurality of first electrodes, and the other 330 are connected to each other in the Y-axis direction to form a plurality of second electrodes. Each of the unit electrodes 330 constituting the second electrodes includes one or more second slits 335. Here, unlike the second slit 235 illustrated in FIG. 2, the second slit 335 illustrated in FIG. 3 has a length direction intersecting an edge of the unit electrode 330 constituting the second electrode, and one end thereof in the length direction is directly connected to the edge of the unit electrode 330. Thus, as shown in FIG. 3, the unit electrodes 330 constituting the second electrodes have a shape in which at least a portion of the edges is open.

The touch screen panel 300 illustrated in FIG. 3 may operate in a similar manner to that of the touch screen panel 200 illustrated in FIG. 2. Namely, the controller IC (not shown) sequentially applies a driving signal to the first electrodes connected to the channels D1 to D8, detects a change in mutual-capacitance from the second electrodes and determines a touch. Here, the one or more second slits 335 having a length direction intersecting the edges of the unit electrodes are formed in the individual unit electrodes 330 included in the second electrodes, thereby improving linearity of a change in capacitance generated by a touch.

Meanwhile, as in FIG. 2, the plurality of first slits 325 may be formed between the unit electrodes 320 and 330. Thus, the second slits 335 directly connected to the edges of the unit electrodes 330 constituting the second electrodes are directly connected to at least portions of the plurality of first slits 325. Also, the second slits 335 may have a length direction intersecting the length direction of the plurality of first slits 325, rather than being in parallel thereto.

Both the touch screen panels 200 and 300 illustrated in FIGS. 2 and 3 are based on the assumption that they operate according to a scheme of detecting a change in the mutual-capacitance, and thus, it is described that the second slits 235 and 335 are formed only in the unit electrodes constituting the second electrodes. However, in a case in which the touch screen panels 200 and 300 sense a touch by detecting a change in self-capacitance, the slits 235 and 335 may also be formed in the first electrodes, as well as in the second electrodes.

Meanwhile, even in the case of FIG. 3, like the embodiment described with reference to FIG. 2, one or more dummy electrodes may be formed in at least one of the plurality of first slits 326 and second slits 335. As described above with reference to FIG. 2, by forming the one or more dummy electrodes within the plurality of first and second slits 325 and 335, a pattern-visible phenomenon of the first and second electrodes can be prevented and even visibility can be implemented.

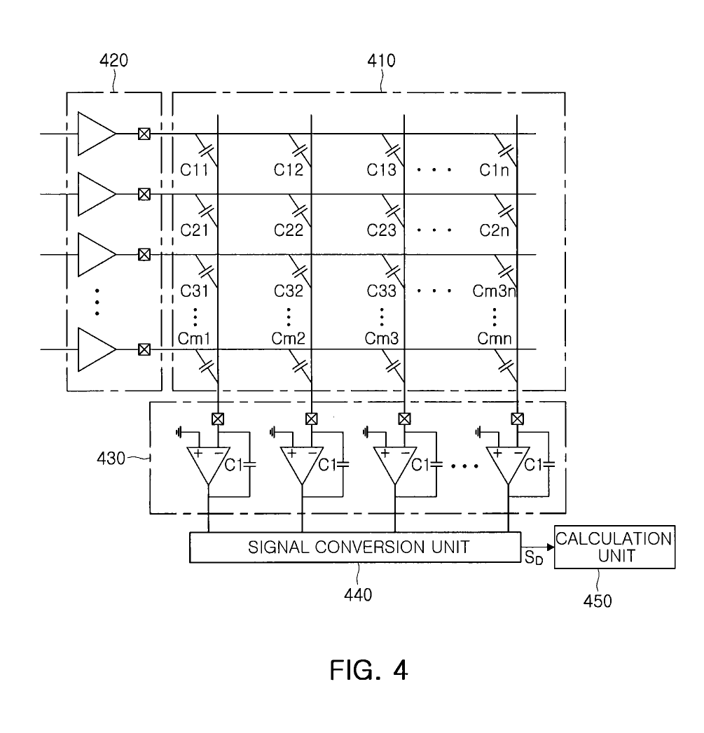

FIG. 4 is a view showing a touch screen apparatus according to an embodiment of the present invention.

With reference to FIG. 4, a touch screen apparatus according to the present embodiment includes a panel unit 410, a driving circuit unit 420, a sensing circuit unit 430, a signal conversion unit 440, and a calculation unit 450. The panel unit 410 includes a plurality of first electrodes extending in a first axis direction, i.e., in a horizontal direction in FIG. 4, and a plurality of second electrodes extending in a second axis direction, i.e., in a vertical direction in FIG. 4, and changes C11 to Cmn in capacitance are made at intersections between the first and second electrodes. The changes C11 to Cmn in capacitance made at the intersections between the first and second electrodes may be a change in mutual-capacitance generated by a driving signal applied to the first electrodes by the driving circuit unit 420. Meanwhile, the driving circuit unit 420, the sensing circuit unit 430, the signal conversion unit 440, and the calculation unit 450 may be implemented as a single integrated circuit (IC).

The driving circuit unit 420 applies a certain driving signal to the first electrodes of the panel unit 410. The driving signal may be a square wave signal, a sine wave signal, a triangle wave signal, or the like, which has a predetermined cycle and amplitude, and may be sequentially applied to the plurality of first electrodes. FIG. 4 illustrates that circuits for generating and applying the driving signal are individually connected to the plurality of first electrodes, respectively; however, a single driving signal generation circuit may be provided and a driving signal may be applied to each of the plurality of first electrodes by using a switching circuit.

The sensing circuit unit 430 may include an integrating circuit for sensing the changes C11 to Cmn in capacitance from the second electrodes. The integrating circuit may include at least one operational amplifier and a capacitor C1 having a certain capacity. An inverting input terminal of the operational amplifier may be connected to the second electrodes to convert the changes C11 to Cmn in capacitance into an analog signal such as a voltage signal, or the like, and output the same. When the driving signal is sequentially applied to each of the plurality of first electrodes, changes in capacitance may be simultaneously detected from the plurality of second electrodes, so the number of integrating circuits may correspond to the number (m) of the second electrodes.

The signal conversion unit 440 generates a digital signal S_{D} from the analog signal generated by the integrating circuit. For example, the signal conversion unit 440 may include a time-to-digital converter (TDC) circuit for measuring a time required for the voltage type analog signal output from the sensing circuit unit 430 to reach a certain reference voltage level and converting the measured time into the digital signal S_{D}, or an analog-to-digital converter (ADC) circuit for measuring a variation in a level of the analog signal output from the sensing circuit unit 430 that changes during a certain period of time and converting the measured variation into the digital signal S_{D}.

The calculation unit 450 determines a touch applied to the panel unit 410 by using the digital signal S_{D}. In an embodiment, the calculation unit 450 may determine the number of touches applied to the panel unit 410, coordinates of the touches, movements during the touches, and the like.

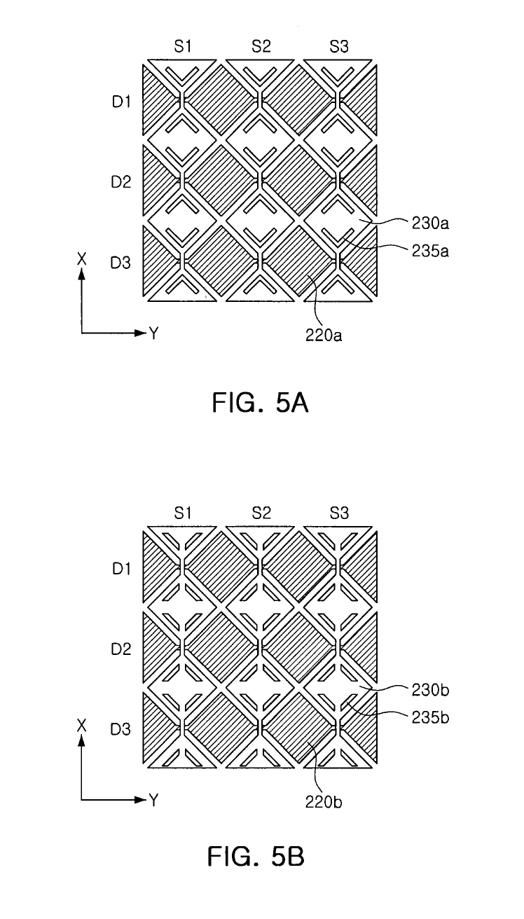

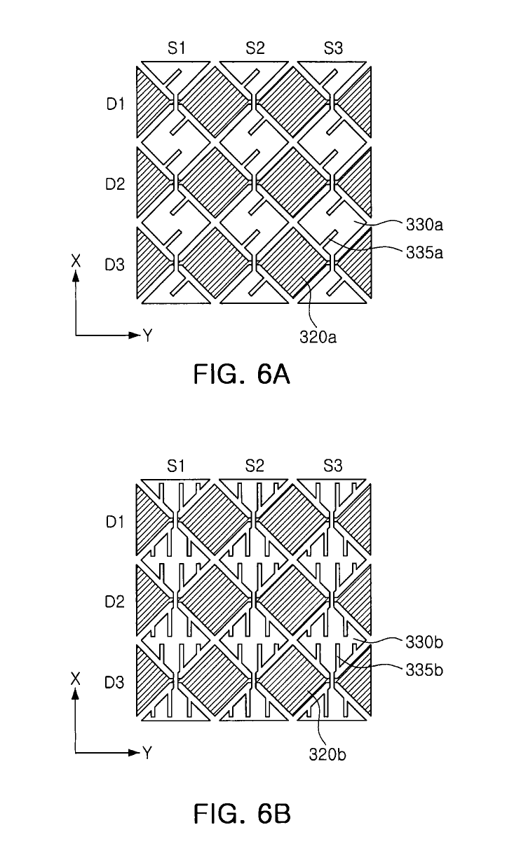

FIGS. 5A, 5B, 6A, and 6B are views explaining slits included in electrodes of a touch screen apparatus according to an embodiment of the present invention.

First, with reference to FIG. 5A, one or more second slits 235a having such a shape as shown in FIG. 2 are formed in unit electrodes 230a constituting second electrodes, respectively. Also, a plurality of first slits 225a may be formed between unit electrodes 220a constituting first electrodes and the unit electrodes 230a constituting the second electrodes. In comparison to the unit electrodes 220a and 230a defined as having a diamond shape or an equilateral triangular shape, each second slit 235a may have a V shape formed of two elongated rectangles respectively provided to be parallel to edges of the unit electrode. One or more second slits 235a are provided within a single unit electrode 230a, and the entirety of the second slits 235a may be formed to be included within the unit electrode. Hereinafter, for the sake of explanation, slits having a form in which the entirety thereof is included within the unit electrode as shown in FIG. 5A will be defined as opening slits.

FIG. 5B is a view explaining opening slits having a form different from that of FIG. 5A. With reference to FIG. 5B, each of the unit electrodes 230b constituting the second electrodes includes two or four opening slits 235b. The opening slits 235b parallel to the respective edges of the unit electrodes 230b or parallel to the plurality of first slits 225b are included in the unit electrode 230b having a diamond shape or an equilateral triangular shape, and the entirety of the opening slits 235b may be included within the unit electrodes 230b as defined above. Also, in FIGS. 5A and 5B, the opening slits 235a and 235b may be formed to be adjacent to the edges of the respective unit electrodes 230b and have a length direction parallel to the plurality of first slits 225a and 225b.

The opening slits 235a and 235b illustrated in FIGS. 5A and 5B intersect in an X axis or Y axis direction based on the intersections between the first electrodes 220a and 220b and the second electrodes 230a and 230b. With reference to FIG. 5B, the second slits 235b included in the respective unit electrodes 230b are symmetrical in the X-axis direction and the Y-axis direction. In this manner, by forming the second slits 235b as described above, linearity of a change in capacitance required for determining a touch can be improved and an SNR of a sense signal can be improved.

FIGS. 6A and 6B are views explaining slits included in electrodes of a touch screen apparatus according to an embodiment of the present invention.

With reference to FIGS. 6A and 6B, the touch screen apparatus according to the present embodiment includes second slits 330a and 335b recessed from edges of unit electrodes 330a and 330b into the interior of the unit electrodes 330a and 330b constituting second electrodes. The second slit 335a illustrated in FIG. 6A may extend into the interior of the unit electrode 330a from the edge of the unit electrode 330a. Thus, one end of the second slit 335a illustrated in FIG. 6A may be connected to a first slit 325a. Like the opening slits 235a and 235b of FIGS. 5A and 5B, the second slits 335a illustrated in FIG. 6A also may be symmetrical in an X-axis direction or Y-axis direction based on intersections between the first and second electrodes 320a and 330a.

FIG. 6B illustrates a touch screen apparatus having the second slits 335a having a different shape from that of FIG. 6A. With reference to FIG. 6B, the second slits 335b are formed in the individual unit electrodes 330b constituting the second electrodes, and the second slits 335b have a length direction parallel to the Y-axis direction. Similar to the case of FIG. 5A, one end of the second slit 335b in the length direction may be directly connected to an edge of the unit electrode 330b or a first slit 325b, and thus, a portion of the edge of the unit electrode 330b is open and recessed into the interior thereof. Also, in the touch screen apparatus illustrated in FIG. 6B, the second slits 335b may be symmetrical based on an X-axis direction at intersections between the first and second electrodes 320b and 330b.

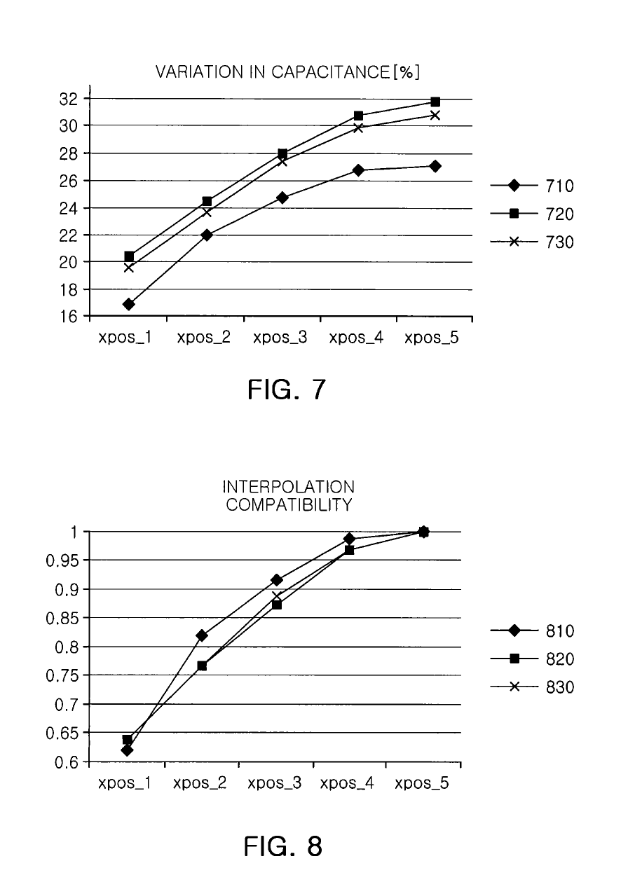

Like the cases of FIGS. 5A and 5B, the touch screen apparatus having the slits 335a and 335b as illustrated in FIGS. 6A and 6B may also obtain the effect of improving a variation in capacitance required for sensing a touch and linearity. Thus, results as shown in FIGS. 7 and 8 may be derived, and in this case, a touch can be accurately sensed in comparison to a general touch screen apparatus without the slits 335a and 335b.

FIGS. 7 and 8 are graphs explaining an operation of a touch screen apparatus according to an embodiment of the present invention. The graphs of FIGS. 7 and 8 show the improvement of linearity in a variation in capacitance and relevant interpolation compatibility that can be obtained from the touch screen apparatuses having the first slits 325a and 325b and the second slits 335a and 335b as illustrated in FIGS. 6A and 6B. In FIGS. 7 and 8, first graphs 710 and 810 represent a variation in capacitance and interpolation compatibility of the touch screen apparatus including general unit electrodes in which only the first slits 325a and 325b are formed without the second slits 335a and 335b. Meanwhile, second graphs 720 and 820 and third graphs 730 and 830 represent a variation in capacitance and interpolation compatibility of the touch screen apparatuses illustrated in FIGS. 6A and 6B.

With reference to FIG. 7, a horizontal axis of the graph represents a variation in capacitance when a touch moves in a state in which only an X-axis coordinate is changed while a Y-axis coordinate is fixed. The variation in capacitance illustrated in FIG. 7 corresponds to a variation in capacitance according to a touched position within unit sensing cells 340a and 340b illustrated in FIGS. 6A and 6B. Hereinafter, for the sake of explanation, the graphs illustrated in FIGS. 7 and 8 will be described based on FIG. 6A.

With reference to FIGS. 6A and 7, as the X-axis coordinate of a touch within a single unit cell 340a moves from xpos_1 to xpos_5, the variation in capacitance increases gradually. A general characteristic in which the variation in capacitance increases according to a touched position are common in the first graph 710 corresponding to the touch screen apparatus without the second slits 335a and in the second graph 720 corresponding to the touch screen apparatus of FIG. 6A. However, as shown in FIG. 7, the variation in capacitance is higher in the second graph 720 than in the first graph 710 with respect to all the X-axis coordinates xpos_1˜xpos_5. The variation in capacitance defined in FIG. 7 is represented by Equation 1 shown below.

$$Variation in capacitance = \frac{Δ {C}_{m}}{{C}_{untouch}} \qquad [ Equation 1 ]$$

In Equation 1, □Cₘ is a variation in a capacitance value that can be obtained when a touch is generated based on a case in which a touch is not generated, and C_{untouch} is a capacitance value detected when a touch is not generated. Thus, in the graph of FIG. 7, a large variation in capacitance means that a sense signal having a relatively high strength can be obtained when a touch having the same overlap area as that of a unit electrode included in the unit sensing cell 340a is generated. Thus, by detecting a fine touch or by improving an SNR of a sense signal, an effect of obtaining accuracy in sensing a touch can be obtained.

The graph in FIG. 8 represents interpolation compatibility that can be obtained when a touch moves only in an X-axis direction. The interpolation compatibility in FIG. 8 may be obtained by normalizing a variation in capacitance.

Unlike the case of FIG. 7, a fourth graph 840 is additionally illustrated in FIG. 8. The fourth graph 840 is a reference graph required for calculating coordinates of a touch within the controller IC configured to determine a touch. For example, it may be assumed that linearity with respect to coordinates of a touch in the panel unit of the touch screen apparatus is already guaranteed within the controller IC. Thus, when a touch is actually generated at xpos_2 and 0.8 is obtained as corresponding data, the controller IC may calculate coordinates, at which the touch was generated, as xpos_3, rather than xpos_2, according to the fourth graph 840.

With reference to FIG. 8, the first graph 810 corresponding to the general touch screen apparatus is significantly different from the fourth graph 840. For example, when a touch is actually generated at xpos_2, data of about 0.82 may be obtained accordingly. However, since the controller IC calculates coordinates of the touch based on the fourth graph 840, the coordinates calculated by the controller IC may be a value exceeding xpos_3.

With reference to the second and third graphs 820 and 830 illustrating the cases of the touch screen apparatus including the first slits 325a and 325b and the second slits 335a and 335b according to the embodiment of the present invention, data values according to a change in the coordinates of a touch have a linear shape similar to the fourth graph 840. Thus, although the controller IC calculates the coordinates of a touch based on the fourth graph 840, a relatively small error occurs in comparison to the general touch screen apparatus corresponding to the first graph 810, and thus, the accuracy of detecting a touch can be enhanced.

As set forth above, according to embodiments of the invention, in order to guarantee linearity of a change in capacitance required for sensing according to a touched position and improve an SNR of the change in capacitance, a plurality of first slits are formed between electrodes having a certain repetitive pattern and one or more second slits are formed within some of the electrodes. Thus, a difference between a change in capacitance actually generated according to coordinates of a touch and a change in capacitance recognized by a controller IC is reduced, thereby accurately sensing a touch without having to provide an additional circuit configuration or add an algorithm to the controller IC. In addition, in applying a touch screen apparatus to a mobile device, or the like, a tuning operation with respect to the controller IC is simplified, enhancing productivity of the touch screen apparatus.

While the present invention has been shown and described in connection with the embodiments, it will be apparent to those skilled in the art that modifications and variations can be made without departing from the spirit and scope of the invention as defined by the appended claims.

What is claimed is:

1. A touch screen panel comprising:
a plurality of first electrodes formed on a substrate and extending in a first axis direction; and
a plurality of second electrodes formed on the substrate and extending in a second axis direction perpendicular to the first axis direction,
wherein a plurality of first slits are provided in a diagonal direction with respect to the first axis direction and the second axis direction between the plurality of first electrodes and the plurality of second electrodes, and
at least one second slit is formed within each of the plurality of second electrodes.

2. The touch screen panel of claim 1, wherein the at least one second slit is formed to intersect with the plurality of first slits within each of the plurality of second electrodes.

3. The touch screen panel of claim 1, wherein a portion of the at least one second slit is formed to be parallel to at least one of the plurality of first slits within each of the plurality of second electrodes.

4. The touch screen panel of claim 1, wherein the at least one second slit is formed to be parallel to any one of the first axis direction and the second axis direction within each of the plurality of second electrodes.

5. The touch screen panel of claim 1, wherein the at least one second slit is formed to have one end in a length direction thereof connected to at least one of the plurality of first slits within each of the plurality of second electrodes.

6. The touch screen panel of claim 1, wherein the at least one second slit is formed to be separated from the plurality of first slits within each of the plurality of second electrodes.

7. The touch screen panel of claim 1, wherein the at least one second slit is formed to be symmetrical in at least one of the first axis direction and the second axis direction based on intersections between the plurality of first electrodes and the plurality of second electrodes within each of the plurality of second electrodes.

8. The touch screen panel of claim 1, further comprising a circuit unit sequentially applying a predetermined driving signal to the plurality of first electrodes, and determining a touch by detecting a change in capacitance from the plurality of second electrodes intersecting the first electrodes to which the driving signal has been applied.

9. The touch screen panel of claim 1, further comprising a dummy electrode formed within at least one of the plurality of first slits and the at least one second slit.

10. A touch screen apparatus comprising:
a panel unit including two or more electrodes and having a plurality of unit sensing cells having a quadrangular shape; and
a circuit unit electrically connected to the plurality of unit sensing cells to determine a touch,
wherein each of the plurality of unit sensing cells includes a plurality of first slits extending in a diagonal direction and one or more second slits parallel to the plurality of first slits,
the plurality of first slits are formed between the two or more electrodes, and
the one or more second slits are formed within at least one of the two or more electrodes.

11. The touch screen apparatus of claim 10, wherein each of the plurality of unit sensing cells having the quadrangular shape includes first and second electrodes intersecting at a center thereof.

12. The touch screen apparatus of claim 11, wherein the first and second electrodes included in each of the plurality of unit sensing cells are connected to first and second electrodes included in an adjacent unit sensing cell.

13. The touch screen apparatus of claim 12, wherein the first electrode included in each of the plurality of unit sensing cells is connected to the first electrode included in the adjacent unit sensing cell in a first axis direction, and
the second electrode included in each of the plurality of unit sensing cells is connected to the second electrode included in the adjacent unit sensing cell in a second axis direction.

14. The touch screen apparatus of claim 13, wherein the one or more second slits are formed to be symmetrical in at least one of the first axis direction and the second axis direction based on the center of each of the plurality of unit sensing cells having the quadrangular shape.

15. The touch screen apparatus of claim 10, wherein the plurality of first slits are formed between the two or more electrodes to be symmetrical in the first axis direction and the second axis direction based on a center of each of the plurality of unit sensing cells having the quadrangular shape.

16. The touch screen apparatus of claim 12, wherein the circuit unit applies a predetermined driving signal to the first electrode and determines a touch by detecting a change in capacitance from the second electrode.

17. The touch screen apparatus of claim 10, wherein each of the plurality of unit sensing cells further includes a dummy electrode provided within at least one of the plurality of first slits and the one or more second slits.
